(19) United States
(12) Patent Application Publication
(10) Pub. No.: US 2017/0234456 A1
(43) Pub. Date: Aug. 17, 2017

(54) HEAT EXCHANGER WITH EXPANSION VALVE BODY FORMED ON INLET HEADER THEREOF

(71) Applicant: DunAn Microstaq, Inc., Austin, TX (US)

(72) Inventors: E. Nelson Fuller, Manchester, MI (US); Parthiban Arunasalam, Austin, TX (US); Joe A. Ojeda, Austin, TX (US); Huazhao Liu, Memphis, TN (US)

(73) Assignee: DunAn Microstaq, Inc., Austin, TX (US)

(21) Appl. No.: 15/417,267

(22) Filed: Jan. 27, 2017

Related U.S. Application Data
(60) Provisional application No. 62/294,057, filed on Feb. 11, 2016.

(51) Int. Cl. F16K 99/00; F28D 1/053; B23P 15/26

(52) U.S. Cl. CPC F16K 99/0011; B23P 15/26; F28D 1/053; F16K 2099/0098

(57) ABSTRACT

A microchannel heat exchanger is configured for use as an evaporator in a fluid cooling system and includes an inlet header, an outlet header, and a plurality of microchannel tubes extending between and in fluid communication with the inlet header and the outlet header. A microvalve actuated hybrid spool valve is attached to and in fluid communication with the inlet header.

### BACKGROUND OF THE INVENTION

This invention relates in general to a heat exchanger in a fluid system. In particular, this invention relates to an improved structure for a brazed aluminum microchannel heat exchanger configured for use as an evaporator in an air-conditioning or refrigeration system.

In certain applications, heat exchangers may be used to cool or heat certain fluids, such as cooling fluid or refrigerant in air conditioning and/or refrigeration applications. In the automotive industry, heat exchangers may be used to cool or heat fluids such as engine oil and transmission fluid. In each of these applications, the heat exchanger typically receives hot fluid from a source of hot fluid. The heat exchanger then cools the fluid and delivers the cool fluid back into the fluid system.

In a conventional air conditioning and/or refrigeration system, a tube and fin type heat exchanger receives the relatively low pressure refrigerant liquid from a conventional expansion device. For example, relatively high pressure refrigerant liquid moves from a condenser to an expansion device, such as a hybrid spool valve, that is configured to restrict the flow of fluid therethrough. As a result of passing through the expansion device, the relatively high pressure refrigerant liquid is changed to a relatively low pressure refrigerant liquid. The relatively low pressure refrigerant liquid is then routed to a heat exchanger or evaporator.

Users of air conditioning and/or refrigeration systems now desire microchannel heat exchangers. However, such microchannel heat exchangers require a more precise control of the flow of refrigerant through the air conditioning and/or refrigeration system than can be achieved with a conventional expansion device or valve.

Additionally, an optimal location for an expansion device is to be positioned as close as possible to the heat exchanger. There are however, undesirable manufacturing processes associated with known microchannel heat exchangers. During manufacture for example, components of the microchannel heat exchanger, such as microchannel tubes, an inlet header, and an outlet header, are typically formed from aluminum and attached by brazing. Such brazing may require exposing the assembled microchannel heat exchanger to temperatures of 1,100° F. or greater. This very high brazing temperature may undesirably distort any machined bores in a valve body of the conventional expansion valve, if the valve body were to be positioned on or near the microchannel heat exchanger during the brazing operation.

Thus, if the valve body of the conventional expansion valve were attached to the heat exchanger prior to brazing, the final machining steps necessary to ensure required bore diameters in the expansion valve body may only be accomplished after brazing. This sequence is required because bores machined into the valve body may become distorted by as much as about 30 μm by the heat used in the brazing operation. A typical machined bore in a conventional expansion valve body has a diameter tolerance of about +/−5 μm, and the brazing operation may cause the machined bore to become out of tolerance if the brazing operation is performed after the bore has been machined. Therefore, in the manufacture of conventional expansion valves, any required brazing operations occur prior to the bores being machined. This process precludes the formation or attachment of a conventional expansion valve body to a heat exchanger prior to brazing.

Thus, it would be desirable to provide an improved structure for a brazed aluminum microchannel heat exchanger that includes an expansion device formed in, or attached to, an inlet of the heat exchanger, and which provides more precise control of the flow of refrigerant through the air conditioning and/or refrigeration system.

### SUMMARY OF THE INVENTION

This invention relates to an improved structure for a brazed aluminum microchannel heat exchanger configured for use as an evaporator in an air-conditioning or refrigeration system. In one embodiment, a microchannel heat exchanger that is configured for use as an evaporator in a fluid cooling system includes an inlet header, an outlet header, and a plurality of microchannel tubes extending between and in fluid communication with the inlet header and the outlet header. A microvalve actuated hybrid spool valve is attached to and in fluid communication with the inlet header.

In a second embodiment, a method of assembling a brazed aluminum microchannel heat exchanger configured for use as an evaporator in a fluid cooling system includes assembling an inlet header, an outlet header, and a plurality of microchannel tubes together to define a heat exchanger sub-assembly, wherein the microchannel tubes extend between and are in fluid communication with the inlet header and the outlet header. A valve block is assembled to the inlet header of the heat exchanger sub-assembly, and the heat exchanger sub-assembly and the valve block are brazed together in a brazing process.

In another embodiment, a brazed aluminum microchannel heat exchanger that is configured for use as an evaporator in a fluid cooling system includes an inlet header, an outlet header, and a plurality of microchannel tubes extending between and in fluid communication with the inlet header and the outlet header. A valve block is attached to an inlet of the inlet header, is in fluid communication with the inlet header, and is configured to house a microvalve actuated hybrid spool valve therein. The valve block includes a microvalve assembly bore and a spool valve assembly bore formed therein. A microvalve assembly is mounted within the microvalve assembly bore, and a spool valve assembly is mounted within the spool valve assembly bore. A closure member is attached within the spool valve assembly bore and configured to retain the spool valve assembly within the spool valve assembly bore. A valve conduit is configured to provide fluid communication between the microvalve assembly bore and the spool valve assembly bore. The microvalve assembly includes a microvalve mounting body configured as a plug with which the microvalve assembly bore may be closed, and the microvalve mounting body is further mounted in a leak-tight manner in the microvalve assembly bore by a metal to metal interference seal defined between the microvalve mounting body and a shoulder formed in the microvalve assembly bore. The closure member is also mounted in a leak-tight manner in the spool valve assembly bore by a metal to metal interference seal defined between the closure member and a shoulder formed in the spool valve assembly bore.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is an elevational view of a microchannel heat exchanger in accordance with this invention.

FIG. 2 is an enlarged elevational view of the valve block illustrated in FIG. 1 showing the first stage microvalve and the second stage spool valve assembly removed for clarity.

FIG. 3 is an alternate enlarged elevational view of the valve block illustrated in FIGS. 1 and 2 showing the microvalve assembly bore and the spool valve assembly bore therein.

FIG. 4 is a bottom view of the valve block illustrated in FIGS. 1 through 3.

FIG. 5 is a cross-sectional view taken along the line 5-5 in FIG. 4.

FIG. 6 is a bottom view of the valve block illustrated in FIGS. 1 through 4 shown with the first stage microvalve and the second stage spool valve assembly removed for clarity.

FIG. 7 is a cross-sectional view taken along the line 7-7 in FIG. 6.

FIG. 8 is a cross-sectional view taken along the line 8-8 in FIG. 6.

FIG. 9 is an end view of the first stage microvalve assembly illustrated in FIGS. 2 and 5.

FIG. 10 is a cross-sectional view taken along the line 10-10 in FIG. 9.

FIG. 11 is an end view of the second stage spool valve assembly illustrated in FIGS. 2 and 5.

FIG. 12 is a cross-sectional view taken along the line 12-12 in FIG. 11.

### DETAILED DESCRIPTION OF THE PREFERRED EMBODIMENTS

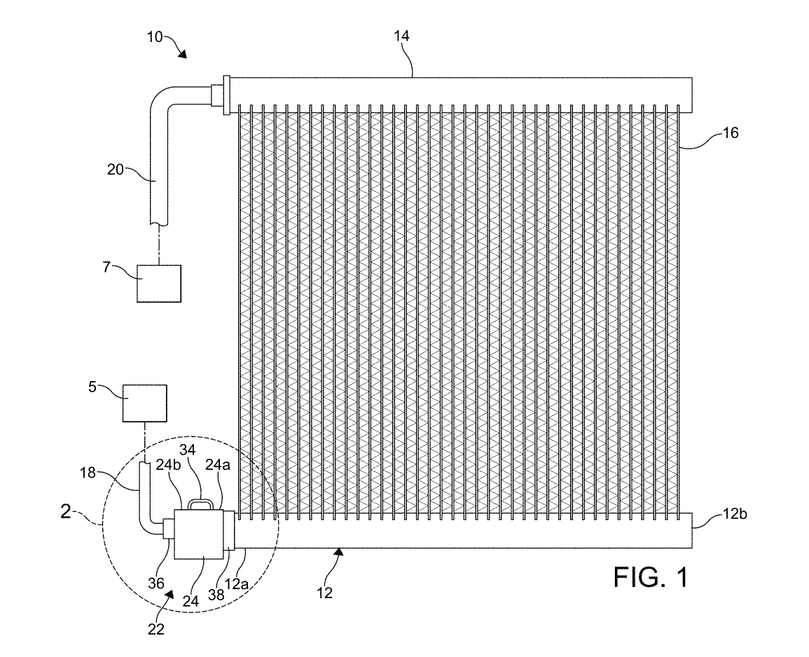

Referring now to the drawings, there is illustrated in FIG. 1 an improved heat exchanger 10 in accordance with this invention. The illustrated heat exchanger is a brazed aluminum microchannel heat exchanger configured for use as an evaporator in an air-conditioning or refrigeration system (not shown). The improvements described herein may also be applied to heat exchangers configured for use in other applications, such as in a fluid system in a motor vehicle.

The heat exchanger 10 includes an inlet header 12 configured to receive cooling fluid from the air-conditioning or refrigeration system, such as from a condenser, schematically shown at 5, and an outlet header 14 configured to discharge the cooling fluid. The inlet header 12 includes a first distal end defining an inlet 12 and a second, closed distal end 12b. A plurality of conventional microchannel tubes 16 extend between, and are in fluid communication with, the inlet header 12 and the outlet header 14. An inlet supply conduit 18 provides the cooling fluid to the inlet header 12 and is in fluid communication between the inlet header 12 and a portion of the air conditioning and/or refrigeration system, such as the condenser 5. An outlet supply conduit 20 is connected to the outlet header 14 and is in fluid communication between the outlet header 14 and a portion of the air conditioning and/or refrigeration system, such as a compressor, schematically shown at 7.

The inlet header 12, the outlet header 14, and the microchannel tubes 16 are typically formed from aluminum and attached by brazing. Alternatively, the inlet header 12, the outlet header 14, and the microchannel tubes 16 may be formed from other metals and non-metals, such as copper.

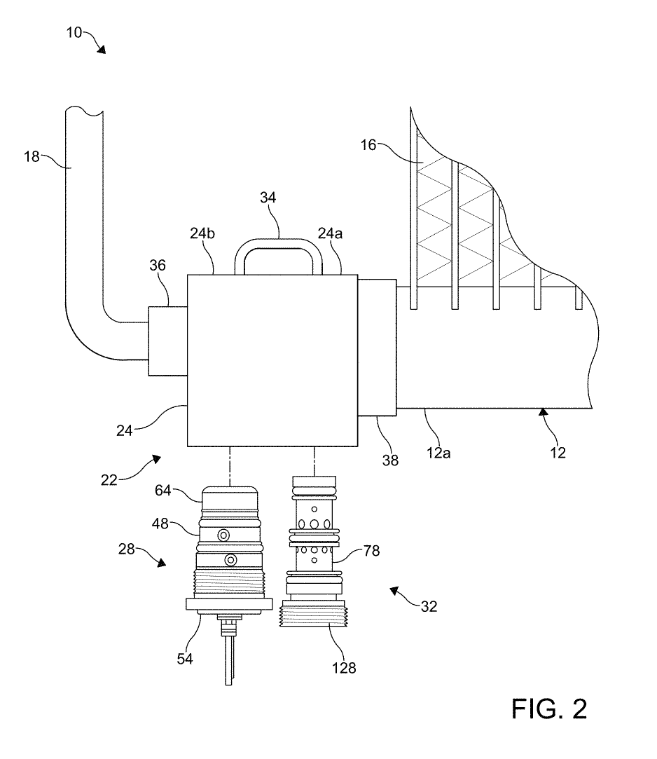

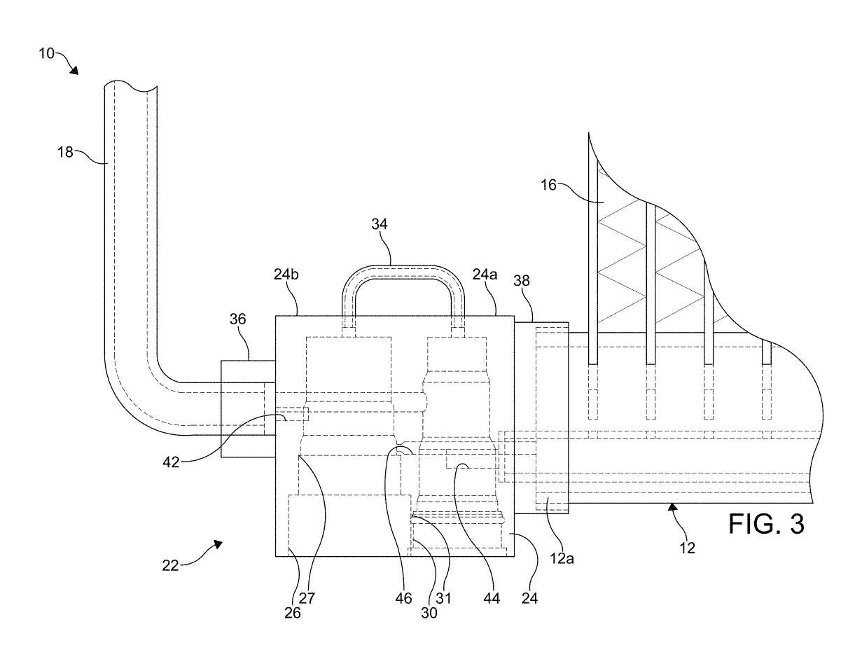

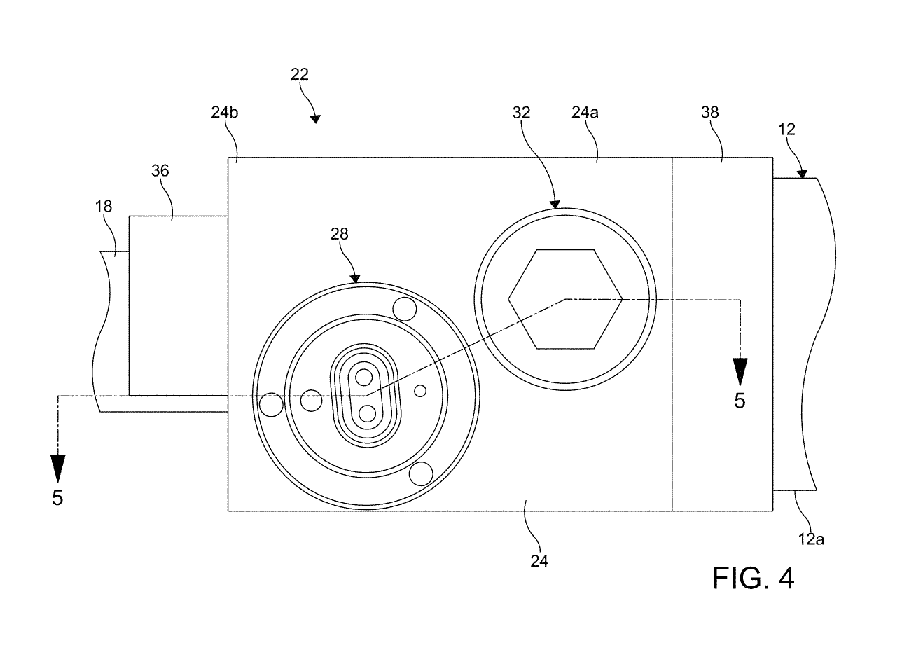

As best shown in FIGS. 2 through 5, an improved expansion device is configured as a microvalve actuated hybrid spool valve 22. The hybrid spool valve 22 is a two-stage proportional control valve having a first stage microvalve 56 and a second stage spool valve assembly 32. In FIGS. 2, 7, and 8, the first stage microvalve 56 and the second stage spool valve assembly 32 are removed for clarity.

The hybrid spool valve 22 includes a valve body or block 24 defining a first or microvalve assembly bore 26 configured to receive a microvalve assembly 28, and a second or spool valve assembly bore 30 configured to receive the spool valve assembly 32. A circumferentially extending shoulder 27 is formed in a surface of the microvalve assembly bore 26 and defines a sealing surface.

The valve block 24 has a substantially rectangular prism shape having a first end 24a and a second end 24b. A valve conduit 34 is attached to a side wall of the valve block 24 and provides fluid communication between the microvalve assembly 28 in the microvalve assembly bore 26 and the spool valve assembly 32 in the spool valve assembly bore 30.

An annular fluid inlet fitting 36 extends outward from the valve block 24 and is configured to have the inlet supply conduit 18 mounted therein. An annular fluid outlet fitting 38 extends outward from the valve block 24 opposite the fluid inlet fitting 36 and is configured to have the inlet header 12 mounted therein.

Fluid flow passages 40 and 42 are formed in the valve block 24 and provide fluid communication between the inlet supply conduit 18 and the spool valve assembly bore 30 and the microvalve assembly bore 26, respectively. Fluid flow passages 44 and 46 are also formed in the valve block 24 and provide fluid communication between the inlet header 12 and the spool valve assembly bore 30, and between the spool valve assembly bore 30 and the microvalve assembly bore 26, respectively.

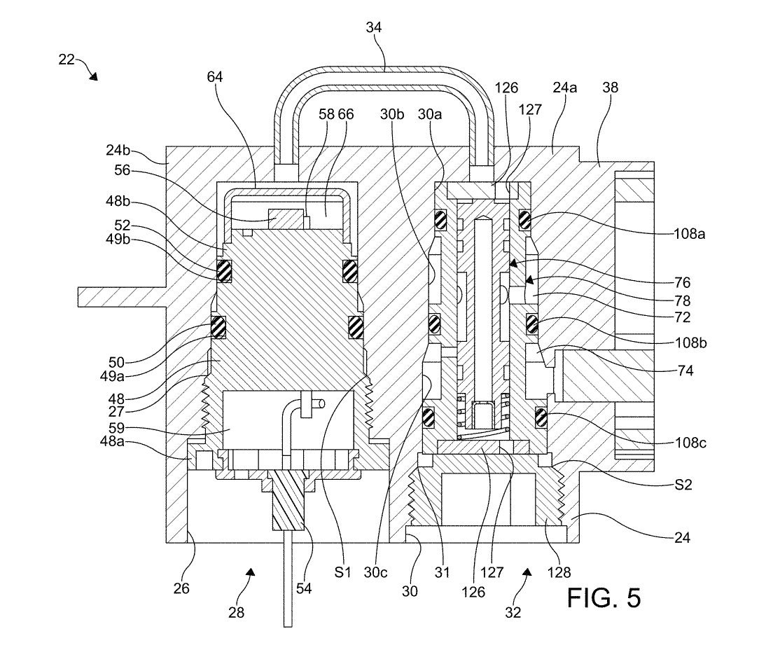

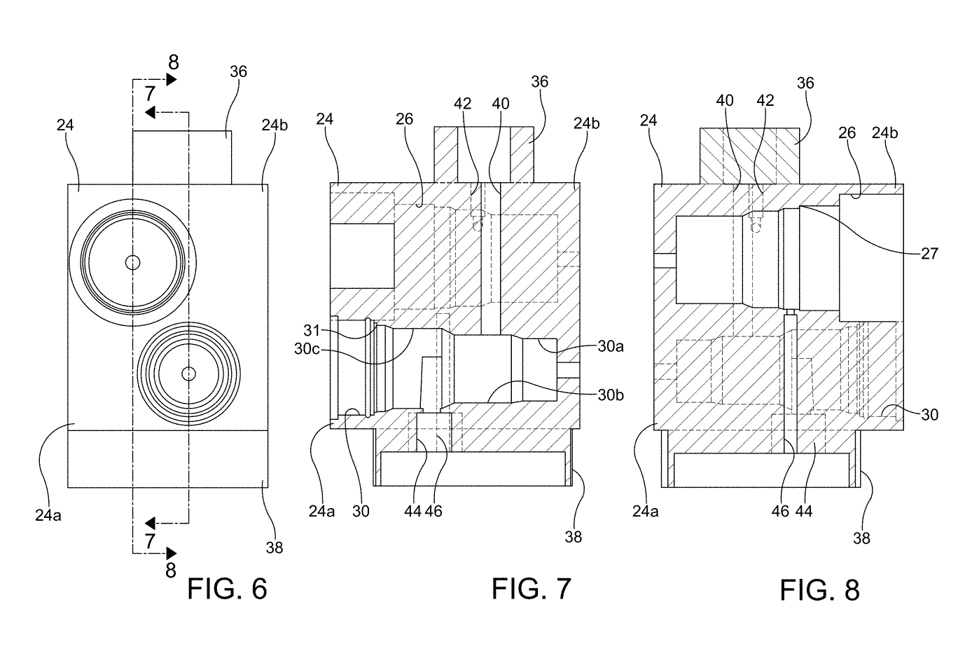

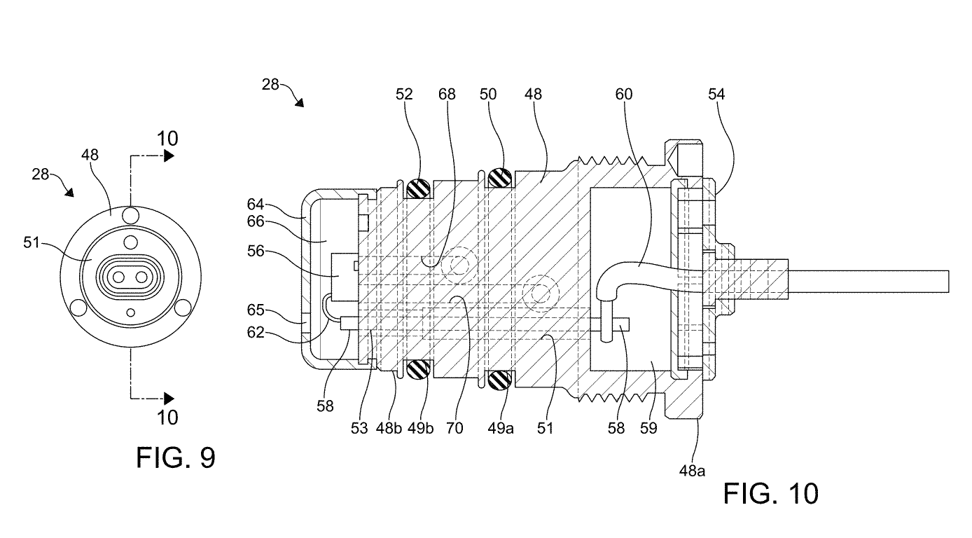

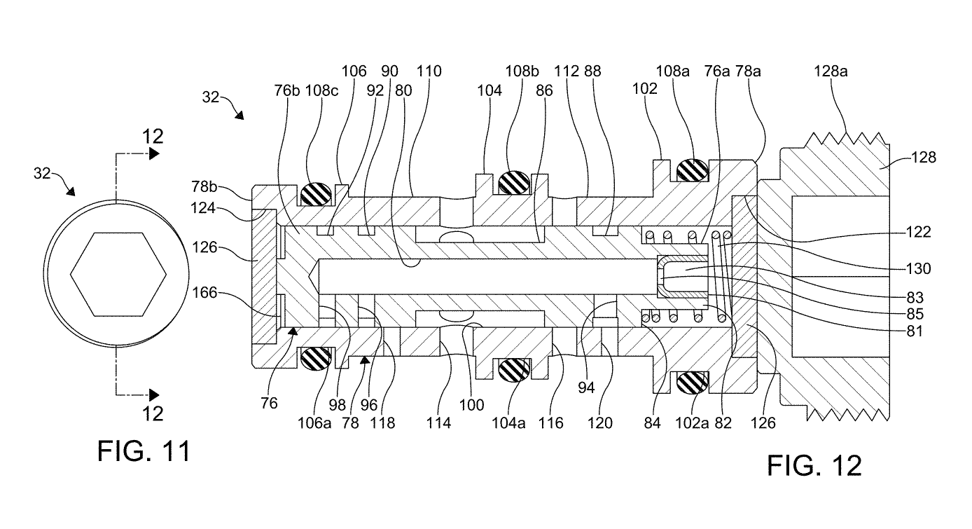

As best shown in FIGS. 5 and 10, the microvalve assembly 28 includes a microvalve mounting body 48 configured as a plug with which the microvalve assembly bore 26 may be closed. The mounting body 48 may be sealingly fixed in the microvalve assembly bore 26 by any suitable means, such as by welding, press fitting, rolling, staking, or as illustrated, held in place by a threaded connection, and made leak-tight by a metal to metal interference seal Si between the mounting body 48 and the shoulder 27 in the microvalve assembly bore 26. Additionally, one or more seals or 0-rings 50 and 52 may be disposed within circumferentially extending sealing grooves, 49a and 49b respectively, formed on an outside surface of the mounting body 48.

An electrical connector 54 extends outwardly from a first axial end 48a of the mounting body 48. The microvalve 56 may be mounted to a second axial end 48b of the mounting body 48 by any suitable method, such as with solder.

Electrical connectors, such as posts or pins 58, extend through passageways 51 (see FIG. 10) between a cavity 59 formed in the first end 48a of the mounting body 48 and the second end 48b of the mounting body 48. Glass seals 53 may be provided between the passageways 51 and the pins 58 at the second end 48b of the mounting body 48 to seal the passageways 51 from a fluid cavity 66, described below. First electrical connectors, such as wires 60, electrically connect the pins 58 to a source of electrical power (not shown) via the electrical connector 54. Second electrical connectors, such as wires 62 electrically connect the microvalve 56 to the pins 58 at the second end 48b of the mounting body 48.

A substantially cup-shaped cap 64 is attached to an outside surface of the mounting body 48 at the second end 48b thereof. The cap 64 has a substantially cylindrical outer surface and includes an opening 65 in an end wall thereof that defines a flow path for fluid between the microvalve 56 and the spool valve assembly bore 30 via the fluid conduit 34. An interior of the cap 64 defines the cavity 66 within which the microvalve 56 is mounted. The illustrated cap 64 is preferably formed from glass filled nylon. Alternatively, the cap 64 may be formed from any desired polymer or other material.

Fluid flow conduits 68 and 70 (see FIG. 10) are formed in the mounting body 48. The fluid flow conduit 68 provides fluid communication between the inlet supply conduit 18 and the microvalve 56. The fluid flow conduit 70 provides fluid communication between the microvalve 56 and the fluid flow passage 46.

Referring to FIGS. 5 and 7, the spool valve assembly bore 30 includes a first diameter portion 30a, a second diameter portion 30b, and a third diameter portion 30c. The second diameter portion 30b is larger than the first diameter portion 30a, and smaller than the third diameter portion 30c. Additionally, a circumferentially extending shoulder 31 is formed in a surface of the spool valve assembly bore 30 and defines a sealing surface.

Referring to FIGS. 5 and 12, a first embodiment of the improved spool valve assembly 32 in accordance with this invention is shown. The spool valve assembly 32 includes a substantially cylindrical spool 76 slidably mounted within a sleeve 78. A first circumferentially extending fluid flow groove 72 is defined between the sleeve 78 and an inside surface of the second diameter portion 30b of the spool valve assembly bore 30, and a second circumferentially extending fluid flow groove 74 is defined between the sleeve 78 and an inside surface of the third diameter portion 30c of the spool valve assembly bore 30.

The spool 76 includes an axially extending bore 80 formed therein and extending from an open first end 76a to a closed second end 76b of the spool 76. The first end 76a of the spool 76 includes a reduced diameter portion 82 defining a shoulder 84. A substantially cup-shaped insert 81 is attached within the bore 80 at the open first end 76a of the spool 76. A feedback pressure chamber 83 may be defined in an interior of the insert 81. The insert 81 has a substantially cylindrical outer surface and includes an opening 85 in an end wall thereof that defines a flow path for fluid between the feedback pressure chamber 83 and the spool bore 80.

A first circumferentially extending groove 86 is formed on an outside surface of the spool 76 intermediate the first and second ends 76a and 76b. A second circumferentially extending groove 88 is formed on an outside surface of the spool 76 near the first end 76a thereof, and a third circumferentially extending groove 90 is formed on an outside surface of the spool 76 near the second end 76b thereof. A circumferentially extending pressure groove 92 is also formed on an outside surface of the spool 76 between the second axial end 76b and the third circumferentially extending groove 90.

A first transverse fluid passageway 94 is formed through a side wall of the spool 76 between the bore 80 and the second circumferentially extending groove 88, and a second transverse fluid passageway 96 is formed through a side wall of the spool 76 between the bore 80 and the third circumferentially extending groove 90. A third transverse fluid passageway 98 is formed through a side wall of the spool 76 between the bore 80 and the circumferentially extending pressure groove 92.

The sleeve 78 is substantially cylindrical and includes an axially extending spool bore 100 formed therein and extending from an open first end 78a to an open second end 78b of the sleeve 78.

A first circumferentially extending sealing portion 102 is formed on an outside surface of the sleeve 78 and defines a first circumferentially extending sealing groove 102a. A second circumferentially extending sealing portion 104 is also formed on an outside surface of the sleeve 78 and defines a second circumferentially extending sealing groove 104a. Additionally, a third circumferentially extending sealing portion 106 is formed on an outside surface of the sleeve 78 and defines a third circumferentially extending sealing groove 106a.

A first annular seal 108a, such as an 0-ring, may be disposed within the first circumferentially extending sealing groove 102a. Similarly, second and third annular seals 108b and 108c, such as 0-rings, may be disposed within the second and third circumferentially extending sealing grooves 104a and 106a, respectively.

A circumferentially extending inlet fluid flow groove 110 is defined in the outside surface of the sleeve 78 between the second and third sealing portions 104 and 106. Similarly, a circumferentially extending outlet fluid flow groove 112 is defined in the outside surface of the sleeve 78 between the first and second sealing portions 102 and 104.

At least one main fluid flow inlet passageway 114 is formed through a side wall of the sleeve 78 between the bore 100 and the inlet fluid flow groove 110, and at least one main fluid flow outlet passageway 116 is formed through the side wall of the sleeve 78 between the bore 100 and the outlet fluid flow groove 112. Additionally, at least one feedback flow inlet passageway 118 is formed through the side wall of the sleeve 78 between the bore 100 and the inlet fluid flow groove 110, and at least one feedback flow outlet passageway 120 is formed through the side wall of the sleeve 78 between the bore 100 and the outlet fluid flow groove 112.

A first cap cavity 122 is formed in the first 78a of the end of the sleeve 78 and a second cap cavity 124 is formed in the second end 78b of the sleeve 78. A closure member or cap 126 is mounted within each of the first and second cap cavities 122 and 124, and may be attached therein by any desired means, such as by threaded attachment, staking, or by welding. The cap 126 may include one or more fluid passageways 127 (see FIG. 5) formed therethrough.

The spool valve assembly 32 is retained in the spool valve assembly bore 30 by a closure member or plug 128. The plug 128 includes a threaded portion 128a configured for threaded attachment within the spool valve assembly bore 30. Alternatively, the plug 128 may be sealingly fixed in the spool valve assembly bore 30 by any suitable means, such as by welding, press fitting, rolling, or staking, and made leak-tight by a metal to metal interference seal S2 (see FIG. 5) between the plug 128 and the shoulder 31 in the spool valve assembly bore 30.

A spring 130 extends between the cap 126 at the first end 78a of the sleeve 78 and the shoulder 84 of the spool 76. The spring 130 urges the second end 76b of the spool 76 toward the second end 78b of the sleeve 78 and thus urges the spool 76 into an un-actuated or closed position, as shown in FIGS. 5 and 12. In the closed position, the main fluid flow outlet passageway 116 is closed by the spool 76, thus preventing fluid flow through the spool valve assembly 32. In the closed position, the feedback flow inlet passageway 118 is also closed by the spool 76, but the feedback flow outlet passageway 120 is open and in fluid communication with the outlet fluid flow groove 112, the second circumferentially extending groove 88, and the first transverse fluid passageway 94. A command chamber 166 may be defined between the axial end face of the second end 76b of the spool 76 and the adjacent second cap 128.

In operation, when it is desired to operate the spool valve assembly 32 and move fluid therethrough, the microvalve 56 may be actuated. The fluid discharged from the microvalve 56 controls a command pressure on the second end 76b of the spool 76. The command pressure acting on the second end 76b of the spool 76 urges the spool 76 against the force of the spring 130 (to the right when viewing FIG. 12).

Thus, when actuated, the microvalve 56 causes the spool 76 to move from the closed position to a fully actuated or fully open position (not shown), and a plurality of partially open positions (not shown) between the closed and fully open positions. In the fully open position, the main fluid flow inlet passageway 114 and the main fluid flow outlet passageway 116 are open, thus permitting a main flow of fluid through the spool valve assembly 32, i.e., through the main fluid flow inlet passageway 114, the first circumferentially extending groove 86 of the spool 76, and the main fluid flow outlet passageway 116. In the fully open position, the feedback flow outlet passageway 120 is closed by the spool 76, but the feedback flow inlet passageway 118 is open and in fluid communication with the inlet fluid flow groove 110, the third circumferentially extending groove 90, and the second transverse fluid passageway 96.

The circumferentially extending pressure groove 92 and the fluid passageway 98 are in fluid communication with the bore 80 and are configured to isolate the command chamber 166 from fluid that may leak around the spool 76 (i.e., from the right of the pressure groove 92 when viewing FIG. 12), and that may overwhelm the fluid pressure introduced by the microvalve 56. Any fluid that may leak into the command chamber 166 is thus tied to the feedback pressure within the bore 114 and the feedback pressure chamber 83.

Advantageously, the fluid conduit 34 may be assembled and brazed to the valve block 24, and the valve block 24 may be assembled and brazed to the inlet header 12 and to the inlet supply conduit 18 during the process of assembling and brazing the heat exchanger 10; i.e., during assembly and brazing of the inlet header 12, the outlet header 14, the microchannel tubes 16, and other required components (not shown) of the heat exchanger 10. The improved hybrid spool valve 22 is thus optimally located at the inlet 12a of the inlet header 12 to control the flow of the cooling fluid, such as refrigerant, into the heat exchanger 10. Further, the microvalve assembly 28 and the spool valve assembly 32, described in detail herein, may be assembled and tested prior to being assembled into the microvalve assembly bore 26 and the spool valve assembly bore 30, respectively.

Microchannel heat exchangers, such as the microchannel heat exchanger 10, may achieve the same cooling capacity as similar conventional tube and fin heat exchangers, but with an advantageous lower refrigerant charge. Microchannel heat exchangers, such as the microchannel heat exchanger 10, are further known to be sensitive to minor variations in refrigerant charge, and may operate inefficiently during such variations in refrigerant charge. The precise control of the flow refrigerant, and thus the precise control of the refrigerant charge, provided by the microvalve actuated hybrid spool valve 22, optimally located at an inlet 12a of the inlet header 12, significantly reduces or eliminates undesirable variation in refrigerant charge to the microchannel heat exchanger 10.

During manufacture of the hybrid spool valve 22, the microvalve 26 and the spool valve assembly bore 30 may be machined in the valve block 24 prior to the valve block 24 being brazed to the microchannel heat exchanger 10.

Each of the microvalve assembly 28 and the spool valve assembly 32 may be formed and assembled independently of the valve block 24. The microvalve assembly bore 26 and the spool valve assembly bore 30 may thus be machined having a diameter tolerance of about +/−5 μm, without being negatively affected by heat from the brazing operation on the microchannel heat exchanger 10. Once assembled, the microvalve assembly 28 and the spool valve assembly 32 may then be mounted within the microvalve assembly bore 26 and the spool valve assembly bore 30, respectively.

The spool valve assembly bore 30 in the valve block 24 is configured to receive, and have fixedly mounted therein, the sleeve 78 rather than the slidable spool 76, as in a conventional expansion valve. Because the spool valve assembly 32 may be sealed within the spool valve assembly bore 30 by the metal to metal interference seal S1, and by the O-rings 108a, 108b, and 108c, the diameter tolerance for the spool valve assembly bore 30 may be relatively larger than the tolerance for a spool bore in the conventional expansion valve, such as about +/−50 μm.

Similarly, because the microvalve assembly 28 may be sealed within the microvalve assembly bore 26 by the metal to metal interference seal S2, and by the 0-rings 50 and 52, the diameter tolerance for the microvalve assembly bore 26 may also be relatively larger than the tolerance for a bore in the conventional expansion valve, such as about +/−50 μm.

Thus, the spool valve assembly bore 30 and the microvalve assembly bore 26 may be machined prior to brazing without causing the spool valve assembly bore 30 and the microvalve assembly bore 26 to become out of tolerance. The relatively small tolerance of about +/−5 μm between the spool 76 and the sleeve 78 in the spool valve assembly 32 may also be achieved and maintained in a manufacturing process independent of, and at a location separate from, the machining, assembly, and brazing steps required to manufacture and assemble the valve block 24 and the microchannel heat exchanger 10 to which the valve block 24 is attached.

Because the spool 76 is enclosed within the sleeve 78 by the caps 126, the spool valve assembly 32 may be easily and safely moved, and may be easily tested independently and separately from the valve block 24, thus saving time and reducing cost.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A microchannel heat exchanger comprising:
an inlet header;
an outlet header;
a plurality of microchannel tubes extending between and in fluid communication with the inlet header and the outlet header; and
a microvalve actuated hybrid spool valve attached to and in fluid communication with the inlet header.

2. The microchannel heat exchanger according to claim 1, wherein the microchannel heat exchanger is a brazed aluminum microchannel heat exchanger.

3. The microchannel heat exchanger according to claim 1, wherein the microvalve actuated hybrid spool valve is housed in a valve block attached to an inlet of the inlet header.

4. The microchannel heat exchanger according to claim 3, wherein the valve block includes a microvalve assembly bore and a spool valve assembly bore formed therein, the microvalve assembly bore configured to receive a microvalve assembly, and the spool valve assembly bore configured to receive a spool valve assembly, wherein a valve conduit provides fluid communication between the microvalve assembly bore and the spool valve assembly bore.

5. The microchannel heat exchanger according to claim 4, wherein each of the microvalve assembly and the spool valve assembly are configured to be assembled and tested independently from the valve block.

6. The microchannel heat exchanger according to claim 4, wherein the microvalve assembly includes a microvalve mounting body configured as a plug with which the microvalve assembly bore may be closed, and wherein the microvalve mounting body is further configured to be mounted in a leak-tight manner in the microvalve assembly bore by a metal to metal interference seal defined between the microvalve mounting body and a shoulder formed in the microvalve assembly bore.

7. The microchannel heat exchanger according to claim 6, wherein the microvalve mounting body further includes at least one circumferentially extending seal between an outside surface of the mounting body and the microvalve assembly bore.

8. The microchannel heat exchanger according to claim 4, wherein the spool valve assembly includes a sleeve and a spool slidably mounted within the sleeve.

9. The microchannel heat exchanger according to claim 8, further including a closure member attached within the spool valve assembly bore and configured to retain the spool valve assembly within the spool valve assembly bore.

10. The microchannel heat exchanger according to claim 9, wherein the closure member is configured to be mounted in a leak-tight manner in the spool valve assembly bore by a metal to metal interference seal defined between the closure member and a shoulder formed in the spool valve assembly bore.

11. The microchannel heat exchanger according to claim 10, wherein the spool valve assembly further includes at least one circumferentially extending seal between an outside surface of the spool valve assembly and the spool bore.

12. The microchannel heat exchanger according to claim 11, wherein the spool valve assembly is configured for movement between a closed position, a fully open position, and a plurality of partially open positions, wherein in the closed position fluid is prevented from flowing through the spool valve assembly, and wherein in the fully open position and in the partially open positions fluid is permitted to flow through the spool valve assembly to the inlet header.

13. A method of assembling a brazed aluminum microchannel heat exchanger comprising:
assembling an inlet header, an outlet header, and a plurality of microchannel tubes together to define a heat exchanger sub-assembly, wherein the microchannel tubes extend between and are in fluid communication with the inlet header and the outlet header;
assembling a valve block to the inlet header of the heat exchanger sub-assembly; and
brazing the heat exchanger sub-assembly and the valve block together in a brazing process.

14. The method of assembling a brazed aluminum microchannel heat exchanger according to claim 13, wherein the valve block defines a housing for a microvalve actuated hybrid spool valve.

15. The method of assembling a brazed aluminum microchannel heat exchanger according to claim 13, further including mounting a microvalve mounting body in a leak-tight manner within a microvalve assembly bore formed in the valve block, wherein the microvalve mounting body is configured as a plug with which the microvalve assembly bore may be closed, and wherein the leak-tight manner includes a metal to metal interference seal defined between the mounting body and a shoulder formed in the microvalve assembly bore.

16. The method of assembling a brazed aluminum microchannel heat exchanger according to claim 15, further including mounting at least one circumferentially extending seal between an outside surface of the mounting body and the microvalve assembly bore.

17. The method of assembling a brazed aluminum microchannel heat exchanger according to claim 13, further including mounting a spool valve assembly and a closure member in a leak-tight manner within a spool valve assembly bore formed in the valve block, wherein the closure member is configured to retain the spool valve assembly within the spool valve assembly bore, and wherein the leak-tight manner includes a metal to metal interference seal defined between the closure member and a shoulder formed in the spool valve assembly bore.

18. The method of assembling a brazed aluminum microchannel heat exchanger according to claim 17, further including mounting at least one circumferentially extending seal between an outside surface of the spool valve assembly and the spool valve assembly bore.

19. The method of assembling a brazed aluminum microchannel heat exchanger according to claim 17, wherein the spool valve assembly includes a sleeve and a spool slidably mounted within the sleeve, wherein the spool valve assembly is configured for movement between a closed position, a fully open position, and a plurality of partially open positions, wherein in the closed position fluid is prevented from flowing through the spool valve assembly, and wherein in the fully open position and in the partially open positions fluid is permitted to flow through the spool valve assembly to the inlet header.

20. A brazed aluminum microchannel heat exchanger comprising:
an inlet header;
an outlet header;
a plurality of microchannel tubes extending between and in fluid communication with the inlet header and the outlet header;
a valve block attached to an inlet of the inlet header and in fluid communication with the inlet header, the valve block configured to house a microvalve actuated hybrid spool valve therein, wherein the valve block includes a microvalve assembly bore and a spool valve assembly bore formed therein;
a microvalve assembly mounted within the microvalve assembly bore;
a spool valve assembly mounted within the spool valve assembly bore;
a closure member attached within the spool valve assembly bore and configured to retain the spool valve assembly within the spool valve assembly bore; and
a valve conduit configured to provide fluid communication between the microvalve assembly bore and the spool valve assembly bore;
wherein the microvalve assembly includes a microvalve mounting body configured as a plug with which the microvalve assembly bore may be closed, and wherein the microvalve mounting body is further mounted in a leak-tight manner in the microvalve assembly bore by a metal to metal interference seal defined between the microvalve mounting body and a shoulder formed in the microvalve assembly bore; and
wherein the closure member is mounted in a leak-tight manner in the spool valve assembly bore by a metal to metal interference seal defined between the closure member and a shoulder formed in the spool valve assembly bore.
